(19) United States
(12) Patent Application Publication
(10) Pub. No.: US 2002/0141909 A1
(43) Pub. Date: Oct. 3, 2002

(54) Device for carbon monoxide removal by selective oxidation and carbon monoxide selective oxidation removing method

(75) Inventors: Masako Takayama, Utsunomiya-shi (JP); Takahiro Naka, Utsunomiya-shi (JP); Shoji Isobe, Wako-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: HONDA GIKEN KOGYO KABUSHIKI KAISHA

(21) Appl. No.: 10/055,986

(22) Filed: Jan. 28, 2002

(30) Foreign Application Priority Data
Jan. 31, 2001 (JP) P2001-024931

(51) Int. Cl. B01D 53/34; B01J 8/02

(52) U.S. Cl. 422/168; 422/169; 422/171

(57) ABSTRACT

A device for carbon monoxide removal by selective oxidation including a plurality of carbon monoxide selective oxidation catalyst layers, each of which contains a carbon monoxide selective oxidation catalyst that reduces the concentration of carbon monoxide contained in a gas by oxidation. The carbon monoxide selective oxidation catalyst layers are serially connected to each other, and an amount of a metallic catalyst contained in each of the carbon monoxide selective oxidation catalyst layer is lowest in the carbon monoxide selective oxidation catalyst layer located at the upstream side in the flow direction of the gas and is highest in the carbon monoxide selective oxidation catalyst layer located at the downstream side in the flow direction of the gas.

### BACKGROUND OF THE INVENTION

1. Field of the Invention

The present invention relates to a device for carbon monoxide removal by selective oxidation and a carbon monoxide selective oxidation removing method. More specifically, the present invention relates to a device for carbon monoxide removal by selective oxidation and a carbon monoxide selective oxidation removing method, which are used for selectively oxidizing and removing carbon monoxide contained in a gas when, for instance, hydrogen enriched gas that may be obtained by reforming methanol or hydrocarbons is supplied to a fuel cell as a fuel.

2. Description of Related Art

Carbon monoxide concentration reducing devices for reducing the concentration of carbon monoxide in which an oxidized gas is supplied to a hydrogen enriched gas containing carbon monoxide to preferentially oxidize carbon monoxide to hydrogen are known as disclosed in Japanese Unexamined Patent Application, First Publication No. Hei 11-310402.

In the carbon monoxide concentration reducing device described in the above publication, a plurality of catalysts having a different temperature range at which the catalytic activity thereof exceeds a certain level, i.e., catalysts having a different active temperature range, are placed in series so as to be disposed in a multistage manner as carbon monoxide selective oxidation catalysts that promote carbon monoxide selective oxidation reactions. Also, in the carbon monoxide concentration reducing device, catalysts whose active temperature range is relatively high are disposed in order at the upstream side of a pathway of a gas to be treated (i.e., a reformed gas), and catalysts whose active temperature range is relatively low are disposed in order at the downstream side of a pathway of a gas to be treated in the carbon monoxide concentration reducing device so that carbon monoxide is efficiently reduced even if the temperature of the gas to be treated (i.e., the temperature of the gas at an inlet of the device), which is introduced into the carbon monoxide concentration reducing device, is varied.

However, although the above-mentioned carbon monoxide concentration reducing device, which is an example of the conventional technique, is capable of coping with the temperature change of the gas to be treated, the device may not be able to carry out a desired carbon monoxide reducing treatment if the amount of the gas to be treated or the concentration of carbon monoxide contained in the gas to be treated is changed. That is, when the amount of gas to be treated is large, or when the concentration of carbon monoxide contained in the gas to be treated is high, a proper control of the catalyst temperature may be difficult since the heat generated in the oxidation reaction becomes large and the device may not be able to carry out a desired carbon monoxide reducing treatment.

For instance, when a reformed gas containing hydrogen, which is obtained by reforming methanol or hydrocarbons, is treated, methane may be produced by the reaction of hydrogen, which is produced by the reforming process, with carbon monoxide via a methanation process, which is an exothermic reaction, shown in the chemical formula (1) below, or if carbon dioxide is produced by a carbon monoxide selective oxidation reaction as shown in the chemical formula (2) below, the produced carbon dioxide may be returned to carbon monoxide by the reaction with hydrogen, which is produced by the reforming process, via a reverse shift reaction, which is an endothermic reaction, shown in the chemical formula (3) (i.e., the reaction indicated by the arrow pointing to the right in the chemical formula (3)), and a reduction in the concentration of carbon monoxide cannot be achieved.

$$\begin{matrix}[ Chemical formula 1 ] & \\ CO + 3 {H}_{2} \to {CH}_{4} + {H}_{2} O & ( 1 ) \\ [ Chemical formula 2 ] & \\ CO + \frac{1}{2} {O}_{2} \to {CO}_{2} & ( 2 ) \\ [ Chemical formula 3 ] & \\ {CO}_{2} + {H}_{2} ⇆ CO + {H}_{2} O & ( 3 )\end{matrix}$$

### SUMMARY OF THE INVENTION

The present invention takes into consideration the above-mentioned circumstances, and has as an object to provide a device for carbon monoxide removal by selective oxidation and a carbon monoxide selective oxidation removing method by which carbon monoxide may be efficiently and selectively oxidized even when, for instance, the amount of gas to be treated is changed or the concentration of carbon monoxide contained in the gas to be treated is varied.

In order to achieve the above object, a first aspect of the present invention provides a device for carbon monoxide removal by selective oxidation including carbon monoxide selective oxidation catalyst layers (for instance, the catalyst layers 34a, 44a, and 54a in an embodiment described later) each containing a carbon monoxide selective oxidation catalyst which reduces the concentration of carbon monoxide contained in a gas by oxidation, wherein the carbon monoxide selective oxidation catalyst layers are serially connected to each other, and the amount of metallic catalyst contained in each of the carbon monoxide selective oxidation catalyst layers is larger than the amount in the preceding carbon monoxide selective oxidation catalyst layer from the upstream side (for instance, the first catalyst layer 34a in an embodiment described later) to the downstream side (for instance, the third catalyst layer 54a in an embodiment described later) in the flow direction of the gas.

According to the device for carbon monoxide removal by selective oxidation described above, the concentration (%) of carbon monoxide generated by a reverse shift reaction increases as the length L of a catalyst layer increases, i.e., as the residence time of a gas to be treated at the catalyst layer increases, as shown in, for instance, a graph in FIG. 1 which indicates changes in the concentration (%) of carbon monoxide generated in the reverse shift reaction in accordance with the length L of catalyst layers.

Also, the concentration (%) of carbon monoxide generated by a reverse shift reaction increases as the linear velocity of the gas to be treated decreases, i.e., as the residence time of the gas to be treated at the catalyst layer increases, as shown in, for instance, a graph in FIG. 2 which indicates changes in the concentration (%) of carbon monoxide generated in the reverse shift reaction in accordance with the linear velocity of the gas to be treated, i.e., the output of the device for carbon monoxide removal by selective oxidation.

For this reason, it becomes possible to prevent occurrence of a reverse shift reaction, which is induced by an uncontrolled temperature, by reducing an amount of the metallic catalyst contained in the carbon monoxide selective oxidation catalyst layer which is located at the upstream side in the flow direction of the gas to be treated with respect to the other carbon monoxide selective oxidation catalyst layer located at the downstream side. Also, since the temperature of the gas decreases as it proceeds to the downstream side and an amount of heat generated by the oxidation reaction decreases accordingly, it becomes possible to effectively reduce the concentration of carbon monoxide even at the downstream side by increasing the amount of the metallic catalyst contained in the carbon monoxide selective oxidation catalyst layer located at the downstream side with respect to the other carbon monoxide selective oxidation catalyst layer located at the upstream side.

The present invention also provides a device for carbon monoxide removal by selective oxidation including carbon monoxide selective oxidation catalyst layers (for instance, the catalyst layers 34a, 44a, and 54a in an embodiment described later) each containing a carbon monoxide selective oxidation catalyst which reduces the concentration of carbon monoxide contained in a gas by oxidation, wherein the carbon monoxide selective oxidation catalyst layers are serially connected to each other, and the length of each of the carbon monoxide selective oxidation catalyst layer is longer than the length of the preceding carbon monoxide selective oxidation catalyst layer from the upstream side (for instance, the first catalyst layer 34a in an embodiment described later) to the downstream side (for instance, the third catalyst layer 54a in an embodiment described later) in the flow direction of the gas.

According to the device for carbon monoxide removal by selective oxidation described above, the concentration (%) of carbon monoxide generated by a reverse shift reaction increases as the length L of a catalyst layer increases as shown in FIG. 1. Also, as shown in FIG. 2, the concentration (%) of carbon monoxide generated by a reverse shift reaction increases as the linear velocity of the gas to be treated is lowered.

For this reason, it becomes possible to prevent occurrence of a reverse shift reaction, which is induced by an uncontrolled temperature, by reducing the length of the carbon monoxide selective oxidation catalyst layer which is located at the upstream side in the flow direction of the gas to be treated with respect to the other carbon monoxide selective oxidation catalyst layer located at the downstream side. Also, since the temperature of the gas decreases as it proceeds to the downstream side and an amount of heat generated by the oxidation reaction decreases accordingly, it becomes possible to effectively reduce the concentration of carbon monoxide even at the downstream side by increasing the length of the carbon monoxide selective oxidation catalyst layer located at the downstream side with respect to the other carbon monoxide selective oxidation catalyst layer located at the upstream side.

In another aspect of the present invention, the device for carbon monoxide removal by selective oxidation further includes an air introducing unit (for instance, the air supply unit 12 in an embodiment described later), and a gas temperature controlling unit (for instance, the heat exchanging unit 11 in an embodiment described later), and the air introducing unit and the gas temperature controlling unit are disposed at the upstream side of the carbon monoxide selective oxidation catalyst layer.

According to the device for carbon monoxide removal by selective oxidation described above, since the air introducing unit and the gas temperature controlling unit are disposed at the upstream side of each of the carbon monoxide selective oxidation catalyst layers serially connected, it becomes possible to independently control the temperature of each of the carbon monoxide selective oxidative catalyst layers. Accordingly, the composition, etc., of the gas to be treated may be properly controlled by adjusting the temperature range at which the catalyst activity exceeds a predetermined level, i.e., the active temperature range, or the amount of air supplied.

In yet another aspect of the present invention, the above device for carbon monoxide removal by selective oxidation further includes a reactor provided between the carbon monoxide selective oxidation catalyst layers serially connected.

In yet another aspect of the present invention, the above carbon monoxide selective oxidation removal further includes a second carbon monoxide selective oxidation catalyst layer connected to the carbon monoxide selective oxidation catalyst layer in a parallel manner.

In yet another aspect of the present invention, the metallic catalyst includes a precious metal.

According to the device for carbon monoxide removal by selective oxidation described above, precious metals, such as Pt, Rh, Pd, Ir, Ru, and Os, are properly selected and used as the metallic catalyst. Also, an alloy formed by a suitable combination of these precious metals may be used to properly adjust the active temperature range of the carbon monoxide selective oxidation catalyst layer.

The present invention also provides a carbon monoxide selective oxidation removing method in which the concentration of carbon monoxide contained in a gas is reduced by making the gas pass through a plurality of carbon monoxide selective oxidation catalyst layers (for instance, the catalyst layers 34a, 44a, and 54a in an embodiment described later), including a first step (for instance, step S04 or step S08 in an embodiment described later) in which the gas is passed through a first carbon monoxide selective oxidation catalyst layer having a relatively small amount of a metallic catalyst (for instance, the first catalyst layer 34a or the second catalyst layer 44a in an embodiment described later); and a second step (for instance, step S08 or step S12 in an embodiment described later) carried out subsequently to the first step in which the gas is passed through a second carbon monoxide selective oxidation catalyst layer having a relatively large amount of a metallic catalyst (for instance, the second catalyst layer 44a or the third catalyst layer 54a in an embodiment described later).

According to the carbon monoxide selective oxidation removing method described above, the concentration (%) of carbon monoxide generated by a reverse shift reaction increases as the length L of a catalyst layer increases as shown in FIG. 1. Also, as shown in FIG. 2, the concentration (%) of carbon monoxide generated by a reverse shift reaction increases as the linear velocity of the gas to be treated is lowered.

For this reason, it becomes possible to prevent occurrence of a reverse shift be reaction, which is induced by an uncontrolled temperature, by introducing a gas to be treated to the carbon monoxide selectively oxidative layer having a relatively small amount of the metallic catalyst in the first step. Then, in the second step, since the temperature of the gas decreases and an amount of heat generated by the oxidation reaction decreases accordingly, it becomes possible to effectively reduce the concentration of carbon monoxide by introducing the gas to be treated to the carbon monoxide selectively oxidative layer having a relatively large amount of the metallic catalyst.

In yet another aspect of the invention, the metallic catalyst used in the above carbon monoxide selective oxidation removing method includes a precious metal.

According to the carbon monoxide selective oxidation removing method described above, metals including precious metals, such as Pt, Rh, Pd, Ir, Ru, and Os, are properly selected and used as the metallic catalyst. Also, an alloy formed by a suitable combination of these precious metals may be used to properly adjust the active temperature range of the carbon monoxide selective oxidation catalyst layer.

The present invention also provides a carbon monoxide selective oxidation removing method in which the concentration of carbon monoxide contained in a gas is reduced by making the gas pass through a plurality of carbon monoxide selective oxidation catalyst layers (for instance, the catalyst layers 34a, 44a, and 54a in an embodiment described later) including a first step (for instance, step S04 or step S08 in an embodiment described later) in which the gas is passed through a first carbon monoxide selective oxidation catalyst layer having a relatively short length in the flow direction of the gas (for instance, the first catalyst layer 34a or the second catalyst layer 44a in an embodiment described later); and a second step (for instance, step S08 or step S12 in an embodiment described later) carried out subsequently to the first step in which the gas is passed through a second carbon monoxide selective oxidation catalyst layer having a relatively long length in the flow direction of the gas (for instance, the second catalyst layer 44a or the third catalyst layer 54a in an embodiment described later).

According to the carbon monoxide selective oxidation removing method described above, the concentration (%) of carbon monoxide generated by a reverse shift reaction increases as the length L of a catalyst layer increases as shown in FIG. 1. Also, as shown in FIG. 2, the concentration (%) of carbon monoxide generated by a reverse shift reaction increases as the linear velocity of the gas to be treated is lowered.

For this reason, it becomes possible to prevent occurrence of a reverse shift reaction, which is induced by an uncontrolled temperature, by introducing a gas to be treated to the carbon monoxide selectively oxidative layer having a relatively short length in the flow direction of the gas in the first step. Then, in the second step, since the temperature of the gas decreases and an amount of heat generated by the oxidation reaction decreases accordingly, it becomes possible to effectively reduce the concentration of carbon monoxide by introducing the gas to be treated to the carbon monoxide selectively oxidative layer having a relatively short length in the flow direction of the gas.

In yet another aspect of the invention, the above carbon monoxide selective oxidation removing method further includes a step of introducing air or another gas into the gas to adjust the temperature of the gas (for instance, steps S01 to S03, steps S05 to S07, or steps S09 to S11 in an embodiment described later) prior to the first step and the second step, respectively.

According to the above carbon monoxide selective oxidation removing method, it becomes possible to independently control the temperature of each of the carbon monoxide selective oxidative catalyst layers by carrying out the step of introducing an air to the gas to adjust the temperature of the gas as a pretreatment even when the above-mentioned first and second steps are repeatedly carried out for the gas to be treated. Accordingly, the composition, etc., of the gas to be treated may be properly controlled by adjusting the active temperature range, or the amount of air supplied.

### BRIEF DESCRIPTION OF THE DRAWINGS

Some of the features and advantages of the invention having been described, others will become apparent from the detailed description which follows, and from the accompanying drawings, in which:

FIG. 1 is a graph showing the relationship between the concentration of carbon monoxide (%) generated by a reverse shift reaction and the temperature of the catalyst bed in relation to the length of catalyst layers when the output of the carbon monoxide selectively oxidation removal device is 9 kW (corresponding to the linear velocity of a gas to be treated of 0.17 m/s);

FIG. 2 is a graph showing the relationship between the concentration of carbon monoxide (%) generated by a reverse shift reaction and the temperature of the catalyst bed in relation to the linear velocity of a gas to be treated, i.e., the output of the carbon monoxide selectively oxidation removal device;

FIG. 3 is a diagram showing a side cross-sectional view of the carbon monoxide selectively oxidation removal device according to the first embodiment of the present invention;

FIG. 4 is a graph showing the relationship between the concentration of carbon monoxide and an amount of air supplied in relation to an amount of metallic catalyst;

FIG. 5 is a graph showing the relationship between the concentration of carbon monoxide and the temperature of a metallic catalyst in relation to an amount of the metallic catalyst;

FIG. 6 is a graph showing the relationship between the concentration of carbon monoxide and the length L of a catalyst layer;

FIG. 7 is a graph showing the relationship between the temperature of a catalyst and the length L of a catalyst layer;

FIG. 8 is a diagram showing a side cross-sectional view of the carbon monoxide selectively oxidation removal device according to the second embodiment of the present invention;

FIG. 9 is a flowchart showing the operation of the carbon monoxide selectively oxidation removal device shown in FIG. 8;

FIG. 10 is a graph showing the relationship between the concentration of carbon monoxide and an amount of air supplied to the first selective oxidation removal unit in relation to the temperature of a reformed gas when the output is relatively high (45 kW);

FIG. 11 is a graph showing the relationship between the concentration of carbon monoxide and a catalyst temperature in the first selective oxidation removal unit in relation to the temperature of a reformed gas when the output is relatively high (45 kW);

FIG. 12 is a graph showing the relationship between the concentration of carbon monoxide and an amount of air supplied to the second selective oxidation removal unit in relation to the temperature of a reformed gas when the output is relatively high (45 kW);

FIG. 13 is a graph showing the relationship between the concentration of carbon monoxide and a catalyst temperature in the second selective oxidation removal unit in relation to the temperature of a reformed gas when the output is relatively high (45 kW);

FIG. 14 is a graph showing the relationship between the concentration of carbon monoxide and an amount of air supplied to the third selective oxidation removal unit in relation to the temperature of a reformed gas when the output is relatively high (45 kW);

FIG. 15 is a graph showing the relationship between the concentration of carbon monoxide and a catalyst temperature in the third selective oxidation removal unit in relation to the temperature of a reformed gas when the output is relatively high (45 kW);

FIG. 16 is a graph showing the relationship between the concentration of carbon monoxide and an amount of air supplied to the first selective oxidation removal unit in relation to the temperature of a reformed gas when the output is relatively low (9 kW);

FIG. 17 is a graph showing the relationship between the concentration of carbon monoxide and a catalyst temperature in the first selective oxidation removal unit in relation to the temperature of a reformed gas when the output is relatively low (9 kW);

FIG. 18 is a graph showing the relationship between the concentration of carbon monoxide and an amount of air supplied to the second selective oxidation removal unit in relation to the temperature of a reformed gas when the output is relatively low (9 kW);

FIG. 19 is a graph showing the relationship between the concentration of carbon monoxide and a catalyst temperature in the second selective oxidation removal unit in relation to the temperature of a reformed gas when the output is relatively low (9 kW);

FIG. 20 is a graph showing the relationship between the concentration of carbon monoxide and an amount of air supplied to the third selective oxidation removal unit in relation to the temperature of a reformed gas when the output is relatively low (9 kW); and

FIG. 21 is a graph showing the relationship between the concentration of carbon monoxide and a catalyst temperature in the third selective oxidation removal unit in relation to the temperature of a reformed gas when the output is relatively low (9 kW).

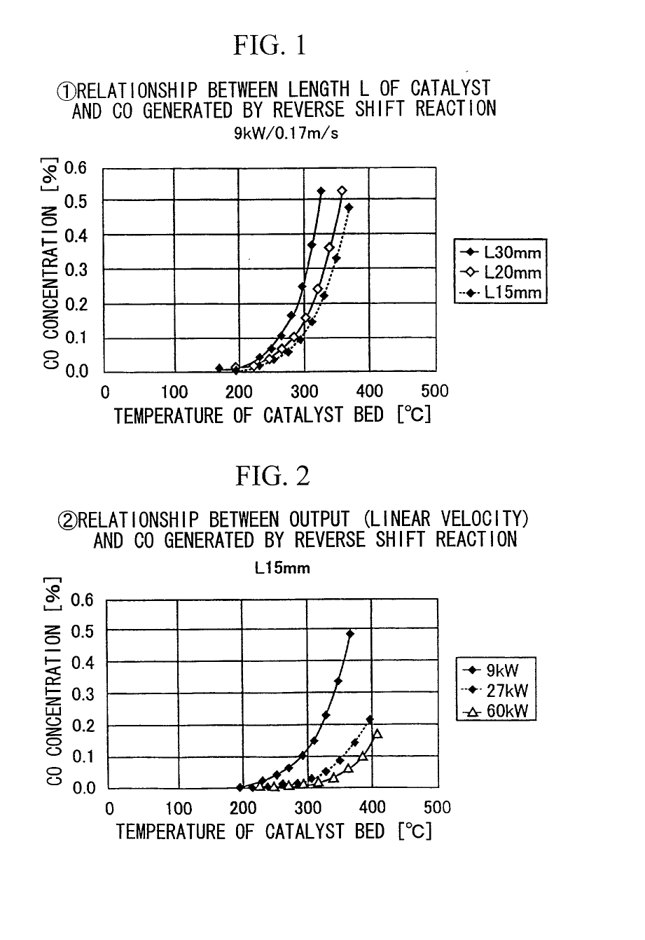

### DETAILED DESCRIPTION OF THE INVENTION

Hereinafter, a device for carbon monoxide removal by selective oxidation and a carbon monoxide selective oxidation removing method according to the first embodiment of the present invention will be described with reference to attached drawings.

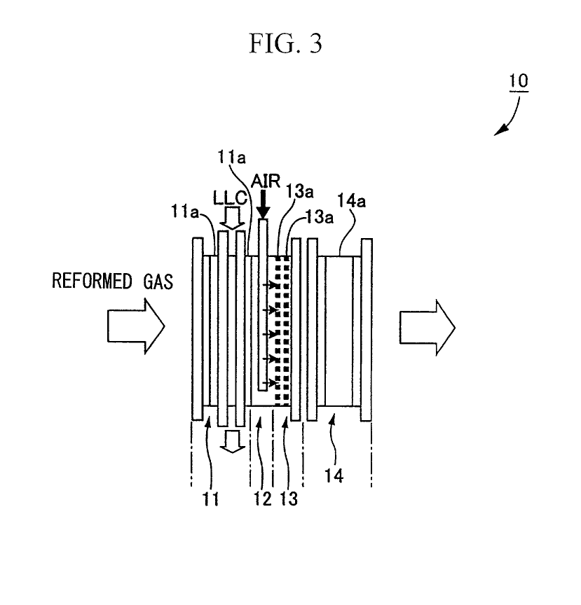

FIG. 3 is a diagram showing the structure of a device for carbon monoxide removal by selective oxidation 10 according to the first embodiment of the present invention.

The device for carbon monoxide removal by selective oxidation 10 of this embodiment of the present invention selectively oxidizes carbon monoxide, which is inevitably generated and lowers the power generation efficiency of a fuel cell (not shown in the figure) by poisoning a Pt catalyst, etc., when a reformed gas having an increased percentage of hydrogen (i.e., a hydrogen enriched reformed gas) is prepared by using a reforming catalyst and a liquid fuel, which is obtained by mixing, for instance, an alcohol type compound, such as methanol, or a hydrocarbon type compound, such as methane, ethane, or gasoline, with water, and is supplied to the fuel cell. As shown in FIG. 3, the device for carbon monoxide removal by selective oxidation 10 includes a heat exchanging unit 11, an air supply unit 12, a gas mixing unit 13, and a catalyst reaction unit 14 in that order along the flow direction of the reformed gas (i.e., the gas to be treated).

The heat exchanging unit 11 may have a honeycomb sandwich structure in which it is sandwiched by, for instance, honeycomb layers 11a and 11a. The heat exchanging unit 11 adjusts the temperature of the reformed gas to be within a predetermined temperature range by using a cooling medium (for instance, LLC shown in FIG. 3) which is externally supplied.

The air supply unit 12 supplies a certain amount of air (denoted as AIR in FIG. 3) as an oxidizing gas for a reformed gas which is discharged from the heat exchanging unit 11.

The gas mixing unit 13 includes, for instance, punching plates 13a and 13a of a two-layered structure. The gas mixing unit 13 diffuses the air supplied by the air supply unit 12 as an oxidizing gas into the reformed gas so as to mix the two.

The catalyst reaction unit 14 includes a catalyst layer 14a having a honeycomb structure in which catalytic metals including precious metals, such as Pt, Rh, Pd, Ir, Ru, and Os, are supported by a carrier on which wash-coating having alumina as a main component is applied. The catalyst reaction unit 14 selectively oxidizes carbon monoxide preferentially to hydrogen, which is contained in the hydrogen enriched reformed gas discharged from the gas mixing unit 13, to carbon dioxide.

Next, an example showing a change in the performance of carbon monoxide selective oxidation removal by the catalyst layer 14a in accordance with a carried amount of catalytic metal (a catalytic metal amount) of the catalyst layer 14a in the catalyst reaction unit 14 will be explained with reference to attached drawings.

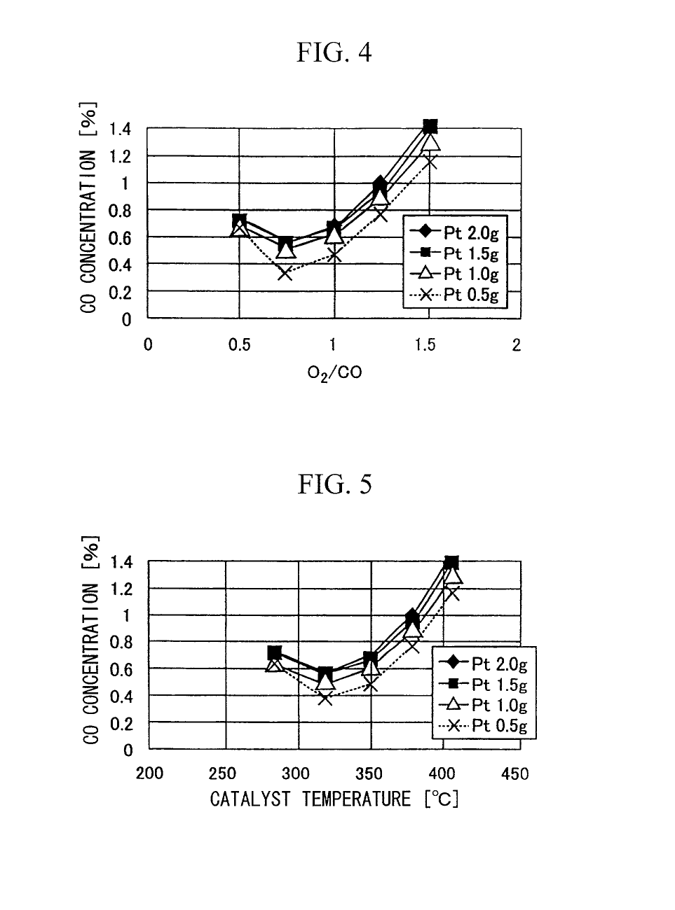

FIG. 4 is a graph showing the relationship between the concentration of carbon monoxide and the amount of air supplied in accordance with the amount of the catalytic metal used. FIG. 5 is a graph showing the relationship between the concentration of carbon monoxide and the temperature of the catalyst in accordance with the amount of the catalytic metal used.

In this embodiment, the reformed gas supplied to the device for carbon monoxide removal by selective oxidation 10 is prepared, for instance, to have the composition shown in Table 1 below. Also, a reforming unit (not shown in the figure), which is provided preceding to the device for carbon monoxide removal by selective oxidation 10, and the heat exchanging unit 11 are controlled so that the output at the catalyst layer 14a becomes 9 kW, which is a relatively low output and corresponds to the linear velocity of the reformed gas of 0.17 m/s, and the temperature of the reformed gas, which is introduced to the catalyst layer 14a, becomes 220° C.

TABLE 1
Composition

| | |
|---|---|
| H₂ | 41.90% |
| CO | 2.00% |
| CO₂ | 17.40% |
| O₂ | 2.00% |
| H₂O | 20.70% |
| N₂ | balance |

Also, in this embodiment, as shown in Table 2, each of the catalyst layers 14a is formed using, as a catalytic metal carried by a carrier having a wash-coating amount of 50 g/L, 2 g/L of Pt and 0.6 g/L of Ni in Example 1, 1.5 g/L of Pt and 0.45 g/L of Ni in Example 2, 1 g/L of Pt and 0.3 g/L of Ni in Example 3, and 0.5 g/L of Pt and 0.15 g/L of Ni in Example 4. Note that the length of each of the catalyst layers 14a is set to be a predetermined length (15 mm, for instance).

TABLE 2

| | Pt [g/L] | Ni [g/L] | Wash-coat amount [g/L] |
|---|---|---|---|
| Ex. 1 | 2 | 0.6 | 50 |
| Ex. 2 | 1.5 | 0.45 | 50 |
| Ex. 3 | 1 | 0.3 | 50 |
| Ex. 4 | 0.5 | 0.15 | 50 |

As shown in the graphs of FIGS. 4 and 5, a maximum amount of carbon monoxide is removed when, for instance, the amount of oxygen to be mixed (i.e., O₂/CO) is about 0.75 with respect to the amount of reformed gas supplied to the device for carbon monoxide removal by selective oxidation 10 and the temperature of the catalyst is about 320° C. In Example 1, the concentration of carbon monoxide is reduced to 0.534% from the initial amount of 2%, and hence, the removal rate is 73.3%. On the other hand, the concentration of carbon monoxide is reduced to 0.3765% from 2%, and hence, the removal rate is 81.2% in Example 4.

That is, the removal rate of carbon monoxide can be improved by 8% by decreasing the amount of Pt, which is a catalytic metal contained in the catalyst layer 14a, to 0.5 g/L from 2 g/L, and the generation of excessive heat due to an oxidative reaction of carbon monoxide is prevented. In this manner, the reverse shift reaction, which is induced by an uncontrolled temperature, may be suppressed, and carbon monoxide can be efficiently removed.

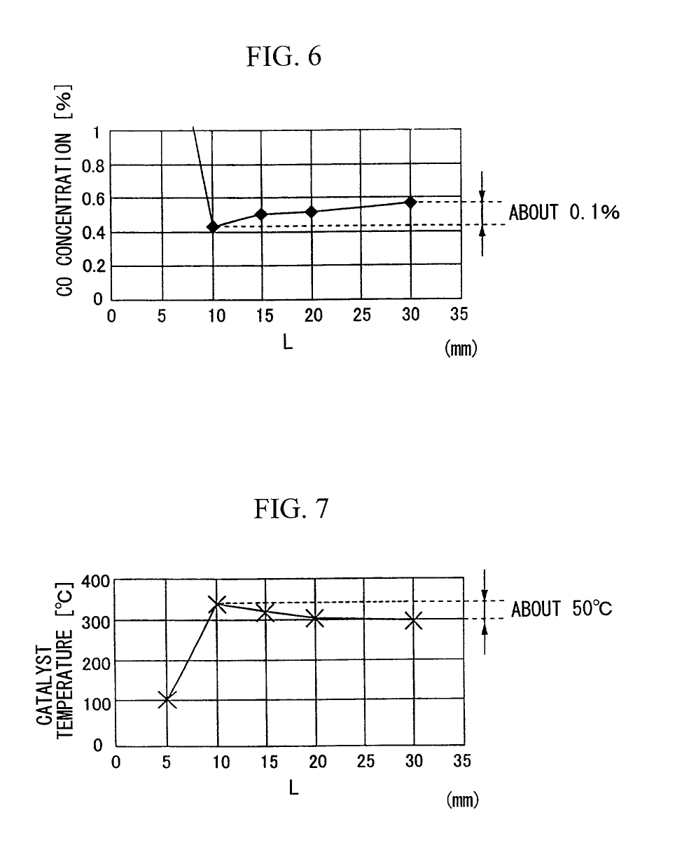

Hereinafter, an embodiment that shows a change in the performance of carbon monoxide selective oxidation removal of the catalyst layer 14a in relation to the changes in the length of the catalyst layer 14a in the flow direction of the reformed gas in the catalyst reaction unit 14 will be explained with reference to the attached drawings. FIG. 6 is a graph showing the relationship between the length L of the catalyst layer 14a and the concentration of carbon monoxide. FIG. 7 is a graph showing the relationship between the length L of the catalyst layer 14a and the temperature of the catalyst.

In this embodiment, the reformed gas supplied to the device for carbon monoxide removal by selective oxidation 10 is also prepared to have the composition shown in Table 1 above. Also, a reforming unit (not shown in the figure), which is provided upstream the device for carbon monoxide removal by selective oxidation 10, and the heat exchanging unit 11 are controlled so that the output at the catalyst layer 14a becomes 9 kW, which is a relatively low output and corresponds to the linear velocity of the reformed gas of 0.17 m/s, and the temperature of the reformed gas, which is introduced to the catalyst layer 14a, becomes 110° C.

In this embodiment, the catalyst layer 14a is formed by using, as a catalytic metal carried by a carrier having a wash-coating amount of 50 g/L, 2 g/L of Pt and 0.6 g/L of Ni. Also, the length L of the catalyst layer 14a is adjusted to be 5 mm in Example 5. Likewise, the length L of the catalyst layer 14a is adjusted to be 10 mm, 15 mm, 20 mm, and 30 mm in Examples 6, 7, 8, and 9, respectively.

As shown in the graphs of FIGS. 6 and 7, when the length L of the catalyst layer 14a exceeds 10 mm, the concentration of carbon monoxide is increased as the temperature of the catalyst decreases. Accordingly, it is considered that the temperature at the upstream side of the catalyst layer 14a is increased due to the heat generated by the oxidation reaction, and carbon monoxide is generated at the downstream side of the catalyst layer 14a due to a reverse shift reaction which is an endothermic reaction.

When the length L of the catalyst layer 14a is 30 mm, for example, the concentration of carbon monoxide is increased by about 0.1% and the temperature of the catalyst is decreased by about 50° C. as compared with the case where the length L of the catalyst layer 14a is 10 mm.

That is, when the carbon monoxide selectively oxidation removal device 10 includes the catalyst layer 14a of a one-stage structure as explained above, the concentration of carbon monoxide contained in the reformed gas may be reduced, for example, to 0.45%, from the initial concentration of 2%.

Next, a device for carbon monoxide removal by selective oxidation and a carbon monoxide selective oxidation removing method according to the second embodiment of the present invention will be described with reference to attached drawings.

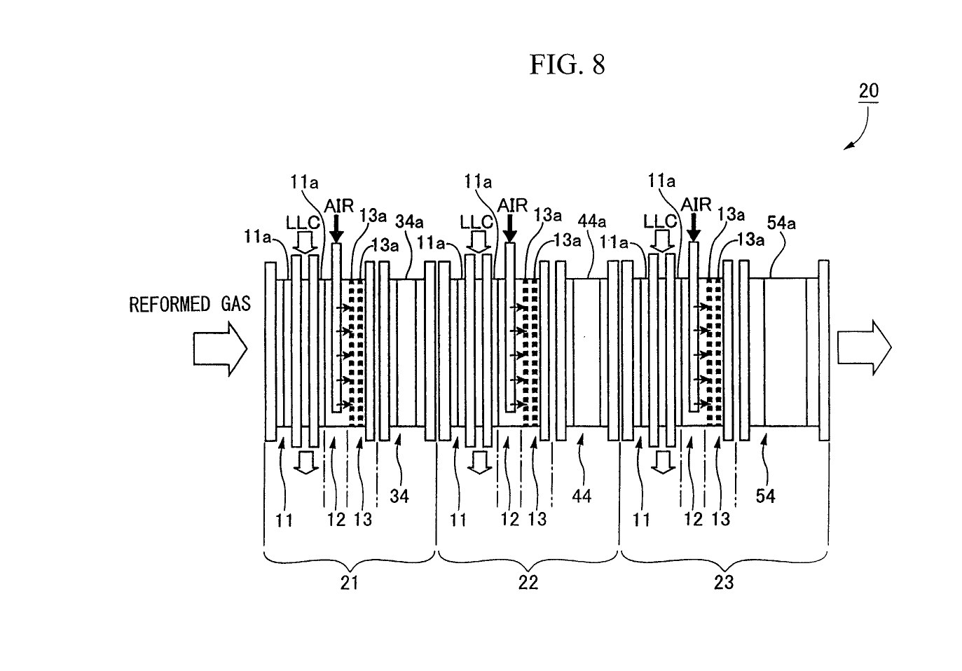

FIG. 8 is a diagram showing the structure of a device for carbon monoxide removal by selective oxidation 20 according to the second embodiment of the present invention. Note that the elements which are the same as those in the device for carbon monoxide removal by selective oxidation 10 according to the first embodiment of the invention are denoted by using the same numerals and the explanation thereof will be omitted.

The device for carbon monoxide removal by selective oxidation 20 of the second embodiment of the present invention includes a plurality of selective oxidation removal units, for example, a first selective oxidation removal unit 21, a second selective oxidation removal unit 22, and a third selective oxidation removal unit 23, which are serially disposed in that order in the flow direction of a reformed gas (i.e., a gas to be treated) as shown in FIG. 8. Each of the selective oxidation removal units 21, 22, and 23 includes a heat exchanging unit 11, an air supply unit 12, a gas mixing unit 13, and a first, a second, and a third catalyst reaction unit 34, 44, and 54, respectively, in that order along the flow direction of the reformed gas.

Each of the catalyst reaction units 34, 44, and 54 includes a catalyst layer 34a, 44a, and 54a, respectively, having a honeycomb structure in which catalytic metals including metals, such as Pt, Rh, Pd, Ir, Ru, and Os, are supported by a carrier on which wash-coating having alumina as a main component is applied. Each of the catalyst reaction units 34a, 44a, and 54a selectively oxidizes carbon monoxide preferentially to hydrogen, which is contained in the hydrogen enriched reformed gas discharged from the gas mixing unit 13, to carbon dioxide.

In this embodiment, each of the catalyst layers 34a, 44a, and 54a has the same amount of carried metallic catalysts per unit volume, and the length of each of the catalyst layers 34a, 44a, and 54a is shortened as proceeding to the upstream side in the flow direction of the reformed gas. That is, the relationship between the length L1 of the first catalyst layer 34a, the length L2 of the second catalyst layer 44a, and the length L3 of the third catalyst layer 54a is expressed as L1<L2<L3.

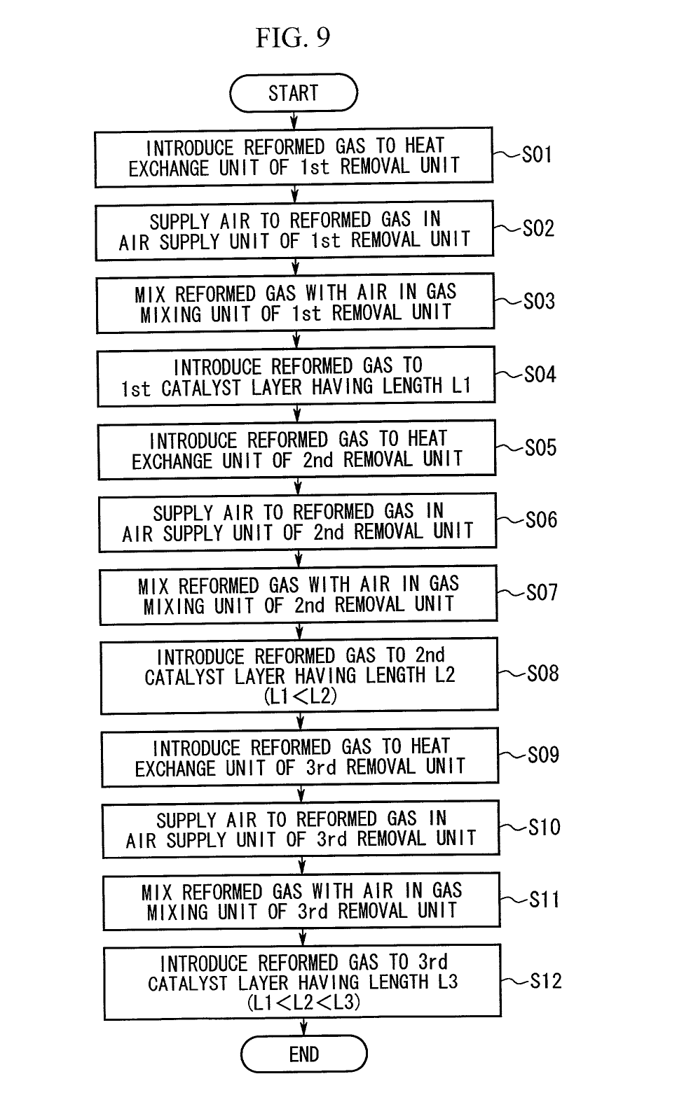

Next, a carbon monoxide selective oxidation removing method for removing carbon monoxide contained in the reformed gas according to an embodiment of the present invention using the device for carbon monoxide removal by selective oxidation 20 having the above-mentioned structure will be explained with reference to attached drawings. FIG. 9 is a flowchart showing operations of the device for carbon monoxide removal by selective oxidation 20.

First, the hydrogen enriched reformed gas, which is discharged from the reforming unit (not shown in the figures) provided preceding to the device for carbon monoxide removal by selective oxidation 20, is passed through the heat exchanging unit 11 of the first selective oxidation removal unit 21 so that the temperature of the catalyst at the first catalyst layer 34a, which will be described later, falls in a predetermined temperature range (step SO 1).

Then, the reformed gas discharged from the heat exchanging unit 11 is passed through the air supply unit 12 so that a predetermined amount of air is supplied to the reformed gas as an oxidizing gas (step S02).

After this, in the gas mixing unit 13, the air supplied by the air supply unit 12 is diffused into the reformed gas, which is passed through the air supply unit 12, so that the air is mixed with the reformed gas (step S03).

Then, the reformed gas, which is mixed with the air in the gas mixing unit 13, is At passed through the first catalyst reaction unit 34 including the first catalyst layer 34a whose length is relatively short (step S04).

After this, the reformed gas, which is discharged from the first catalyst reaction unit 34 of the first selective oxidation removal unit 21, is passed through the heat exchanging unit 11 of the second selective oxidation removal unit 22 so that the temperature of the catalyst at the second catalyst layer 44a, which will be described later, falls in a predetermined temperature range (step S05).

Then, the reformed gas discharged from the heat exchanging unit 11 is passed through the air supply unit 12 so that a predetermined amount of air is supplied to the reformed gas as an oxidizing gas (step S06).

After this, in the gas mixing unit 13, the air supplied by the air supply unit 12 is diffused into the reformed gas, which is passed through the air supply unit 12, so that the air is mixed with the reformed gas (step S07).

Then, the reformed gas, which is mixed with the air in the gas mixing unit 13, is passed through the second catalyst reaction unit 44 having the second catalyst layer 44a whose length is longer than that of the first catalyst layer 34a (step S08).

After this, the reformed gas, which is discharged from the second catalyst reaction unit 44 of the second selective oxidation removal unit 22, is passed through the heat exchanging unit 11 of the third selective oxidation removal unit 23 so that the temperature of the catalyst at the third catalyst layer 54a, which will be described later, falls in a predetermined temperature range (step S09).

Then, the reformed gas discharged from the heat exchanging unit 11 is passed through the air supply unit 12 so that a predetermined amount of air is supplied to the reformed gas as an oxidizing gas (step SI ).

After this, in the gas mixing unit 13, the air supplied by the air supply unit 12 is diffused into the reformed gas, which is passed through the air supply unit 12, so that the air is mixed with the reformed gas (step S11).

Then, the reformed gas, which is mixed with the air in the gas mixing unit 13, is passed through the third catalyst reaction unit 54 having the third catalyst layer 54a whose length is longer than that of the second catalyst layer 44a (step S12).

Finally, the reformed gas discharged from the third selective oxidation removal unit 23 is supplied to, for instance, an anode of the fuel cell (not shown in the figures), and the series of processes is terminated.

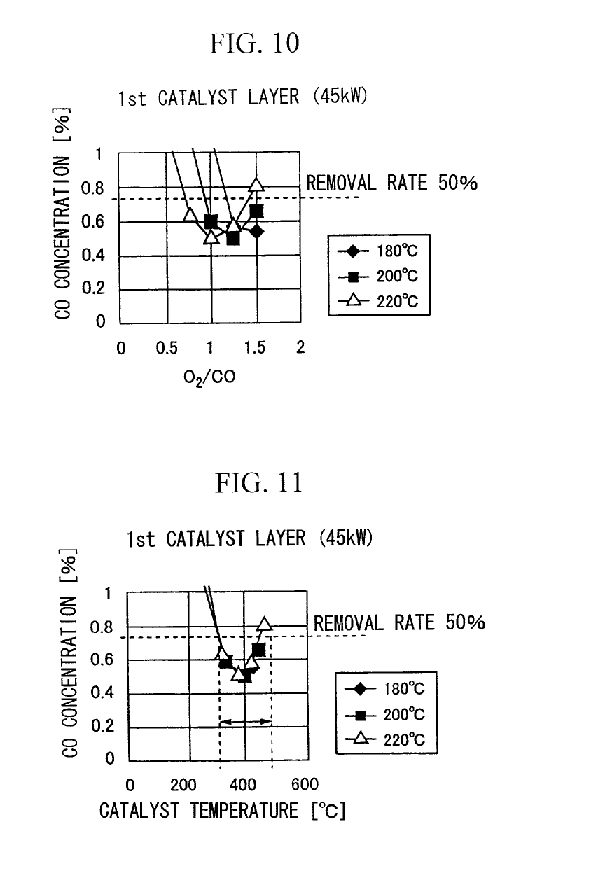

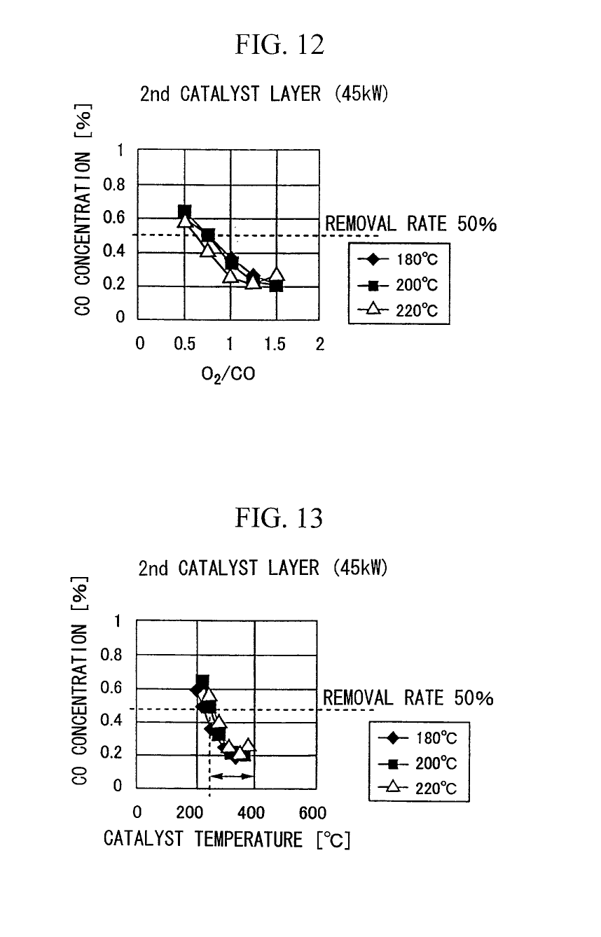

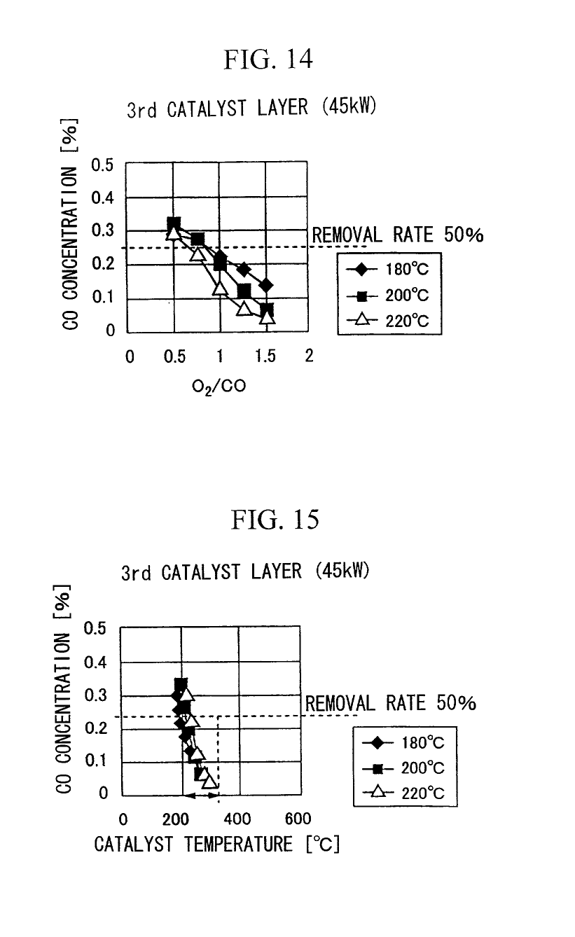

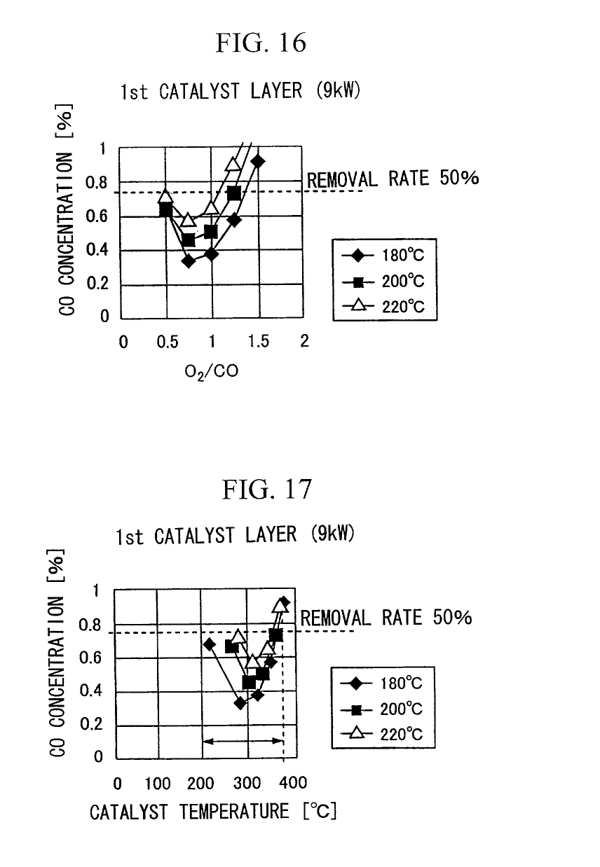

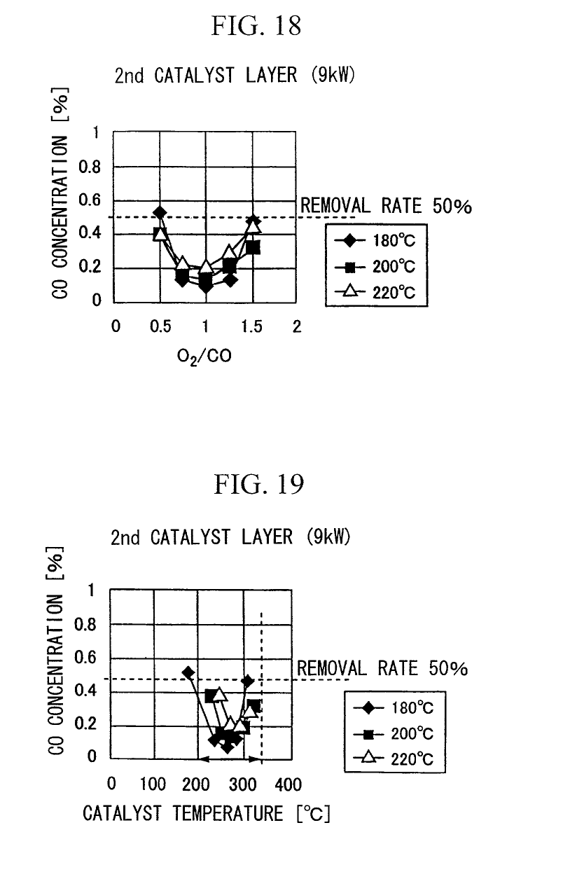

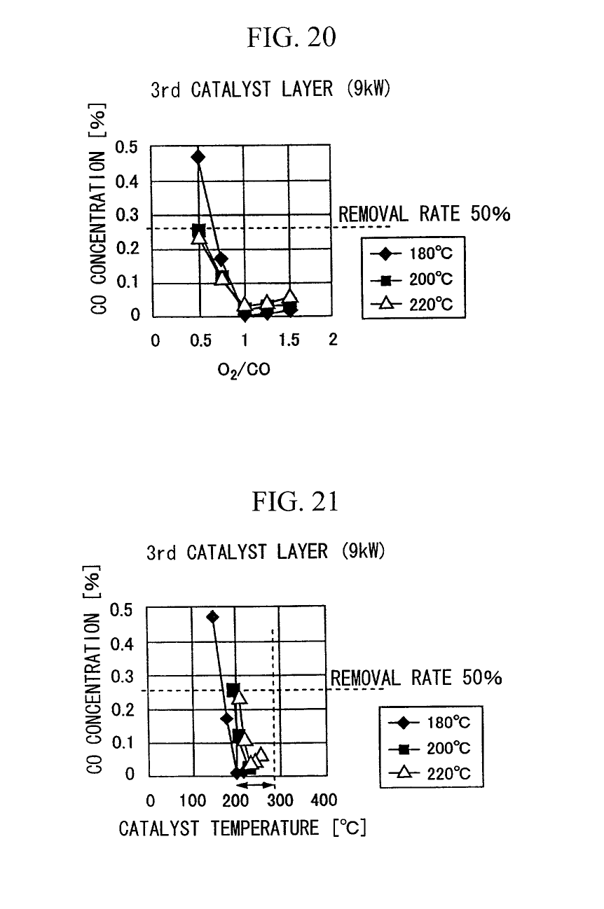

Next, an embodiment of the selective oxidation removal of carbon monoxide contained in a reformed gas using the device for carbon monoxide removal by selective oxidation 20 will be explained with reference to attached drawings. FIGS. 10, 12, and 14, respectively, are graphs showing the relationship between the concentration of carbon monoxide and the amount of air supplied to each of the selective oxidation removal units 21, 22, and 23, when the output is relatively high, in relation to the temperature of the reformed gas. FIGS. 11, 13, and 15, respectively, are graphs showing the relationship between the concentration of carbon monoxide and the temperature of the catalyst at each of the selective oxidation removal units 21, 22, and 23, when the output is relatively high, in relation to the temperature of the reformed gas. FIGS. 16, 18, and 20, respectively, are graphs showing the relationship between the concentration of carbon monoxide and the amount of air supplied to each of the selective oxidation removal units 21, 22, and 23, when the output is relatively low, in relation to the temperature of the reformed gas. FIGS. 17, 19, and 21, respectively, are graphs showing the relationship between the concentration of carbon monoxide and the temperature of the catalyst at each of the selective oxidation removal units 21, 22, and 23, when the output is relatively low, in relation to the temperature of the reformed gas.

In this embodiment, the reformed gas supplied to the first catalyst layer 34a of the first selective oxidation removal unit 21 (i.e., the first stage), the second catalyst layer 44a of the second selective oxidation removal unit 22 (i.e., the second stage), and the third catalyst layer 54a of the third selective oxidation removal unit 23 (i.e., the third stage) of the device for carbon monoxide removal by selective oxidation 20 is prepared, for instance, to have the composition shown in Table 3 below.

Also, in this embodiment, each of the catalyst layers 34a, 44a, and 54a is formed by using, as a catalytic metal carried by a carrier having a wash-coating amount of 50 g/L, 2 g/L of Pt and 0.6 g/L of Ni. The length L of the first catalyst layer 34a is adjusted to be 15 mm. Likewise, the length L2 of the second catalyst layer 44a and the length L3 of the third catalyst layer 54a are adjusted to be 20 mm and 30 mm, respectively.

TABLE 3

| | | |
|---|---|---|
| First Stage | Second Stage | Third Stage |
| Composition | Composition | Composition |

| | | | |
|---|---|---|---|
| H₂ | 41.90% | 41.90% | 41.90% |
| CO | 1.50% | 1.00% | 0.50% |
| CO₂ | 17.40% | 17.40% | 17.40% |
| O₂ | O₂/CO = 0.5-1.5 | O₂/CO = 0.5-1.5 | O₂/CO = 0.5-1.5 |
| H₂O | 20.70% | 20.70% | 20.70% |
| N₂ | balance | balance | balance |

In Example 10, the output at each of the catalyst layers 34a, 44a, and 54a is controlled to be 45 kW, which is a relatively high output and corresponds to the linear velocity of the reformed gas of 0.83 m/s.

Also, in Example 11, the output at each of the catalyst layers 34a, 44a, and 54a is controlled to be 9 kW, which is a relatively low output and corresponds to the linear velocity of the reformed gas of 0.17 m/s.

Moreover, in Examples 10 and 11, the reforming unit (not shown in the figures), which is provided upstream the device for carbon monoxide removal by selective oxidation 20, and the heat exchanging unit 11 of each of the selective oxidation removal units 21, 22, and 23, respectively, are controlled so that the temperature of the reformed gas, which is introduced to each of the catalyst layers 34a, 44a, and 54a, falls in the range between about 180 and 220° C.

Furthermore, the amount of air supplied to the air supply unit 12 of each of the selective oxidation removal units 21, 22, and 23 is adjusted so that the amount of oxygen mixed in the reformed gas (O₂/CO) falls in the range between about 0.5 and 1.5.

In Example 10, in which the relatively high output of 45 kW corresponding to the linear velocity of the reformed gas of 0.83 m/s is employed, the carbon monoxide selective oxidation removal rate of 50% or more can be set for each of the catalyst layers 34a, 44a, and 54a and is distributed among them by adjusting the amount of air supplied by each of the air supply units 12 as an oxidizing gas so that the catalyst temperature of the first catalyst layer 34a falls in the range between about 300 and 450° C., that of the second catalyst layer 44a falls in the range between about 250 and 400° C., and that of the third catalyst layer 54a falls in the range between about 200 and 300° C. when the temperature of the reformed gas introduced to each of the catalyst layers 34a, 44a, and 54a is any of 180° C., 200° C., and 220° C. as shown in FIGS. 10 through 15. Accordingly, it becomes possible to reduce the concentration of carbon monoxide, which passes through the device for carbon monoxide removal by selective oxidation 20, to less than 0.05% from 1.5%.

Similarly, in Example 11, in which the relatively low output of 9 kW corresponding to the linear velocity of the reformed gas of 0.17 m/s is employed, the carbon monoxide selective oxidation removal rate of 50% or more can be set for each of the catalyst layers 34a, 44a, and 54a and is distributed among them by adjusting the amount of air supplied by each of the air supply units 12 as an oxidizing gas so that the catalyst temperature of the first catalyst layer 34a falls in the range between about 200 and 360° C., that of the second catalyst layer 44a falls in the range between about 200 and 350° C., and that of the third catalyst layer 54a falls in the range between about 200 and 280° C. when the temperature of the reformed gas introduced to each of the catalyst layers 34a, 44a, and 54a is any of 180° C., 200° C., and 220° C. as shown in FIGS. 16 through 21. Accordingly, it becomes possible to reduce the concentration of carbon monoxide, which passes through the device for carbon monoxide removal by selective oxidation 20, to less than 0.05% from 1.5%.

As mentioned above, according to the device for carbon monoxide removal by selective oxidation 20 and the carbon monoxide selective oxidation removing method of this embodiment of the present invention, it becomes possible, by establishing the relationship of L1<L2<L3 with respect to the length L1, L2, and L3 of the first catalyst layer 34a, the second catalyst layer 44a, and the third catalyst layer 54a, respectively, which are disposed in that order in the flow direction of the reformed gas, to prevent an occurrence of a reverse shift reaction due to uncontrolled temperature of the reformed gas by preventing the generation of excessive heat in the selective oxidation reaction even when the amount of the reformed gas is large or the concentration of carbon monoxide contained in the reformed gas is high. In addition, since the temperature of the reformed gas is decreased and the generation of heat in the oxidation reaction is also lowered as it proceeds toward the downstream side of the flow of the reformed gas, the concentration of carbon monoxide may be efficiently decreased even at the downstream side by increasing the length of the catalyst as it proceeds from the upstream side to the downstream side of the flow of the reformed gas.

Also, since the heat exchanging unit 11, the air supply unit 12, and the gas mixing unit 13 are disposed at the upstream side of each of the catalyst layers 34a, 44a, and 54a, for instance, the temperature of the reformed gas introduced into each of the catalyst layers 34a, 44a, and 54a can be independently adjusted.

Moreover, the temperature of the catalyst at each of the catalyst layers 34a, 44a, and 54a may be independently adjusted to a predetermined temperature by adjusting the amount of air mixed with the reformed gas by means of the air supply unit 12 and the gas mixing unit 13 of each of the selective oxidation removal units 21, 22 and 23 so that each of the selective oxidation removal units 21, 22 and 23 can be operated under suitable conditions.

Note that although each of the catalyst layers 34a, 44a, and 54a has the same amount of carried metallic catalysts per unit volume and the length of each of the catalyst layers 34a, 44a, and 54a is shortened as progress is made toward the upstream side in the flow direction of the reformed gas in the second embodiment of the present invention described above, the present invention is not limited to such a configuration and, for instance, the length L1, L2, and L3 of the first catalyst layer 34a, the second catalyst layer 44a, and the third catalyst layer 54a, respectively, may be the same (i.e., L1=L2=L3) and the amount of carried metallic catalysts per unit volume may be changed to decrease as progress is made toward to the upstream side in the direction of the flow of the reformed gas. That is, the amount of carried metallic catalysts per unit volume ρ1, ρ2, and ρ3 at each of the catalyst layers 34a, 44a, and 54a, respectively, may be adjusted to be ρ1<ρ2<ρ3 according to another embodiment of the present invention.

In the case described above, the reformed gas, which is mixed with air at the gas mixing unit 13, is passed through: the first catalyst reaction unit 34 including the first catalyst layer 34a whose amount of carried metallic catalyst ρ1 is relatively small in the above-mentioned step S04, the second catalyst reaction unit 44 including the second catalyst layer 44a whose amount of carried metallic catalyst ρ2 is larger than ρ1 of the first catalyst layer 34a in the above-mentioned step S08, and the third catalyst reaction unit 54 including the third catalyst layer 54a whose amount of carried metallic catalyst ρ3 is larger than ρ2 of the second catalyst layer 44a in the above-mentioned step S12.

Also, although a plurality of the selective oxidation removal units, i.e., the first selective oxidation removal unit 21, the second selective oxidation removal unit 22, and the third selective oxidation removal unit 23, are serially disposed in order in the flow direction of the reformed gas in the second embodiment of the present invention described above, the present invention is not limited to such a configuration and, for instance, a suitable reactor, etc., may be placed between the first selective oxidation removal unit 21 and the second selective oxidation removal unit 22, and/or between the second selective oxidation removal unit 22 and the third selective oxidation removal unit 23 to form a modified device for carbon monoxide removal by selective oxidation 20.

Moreover, suitable selective oxidation removal units including a plurality of catalyst layers, which are disposed in a parallel manner, for instance, may be provided in each of the serially disposed selective oxidation removal units 21, 22, and 23. That is, a plurality of catalyst layers may be disposed in a parallel manner partially in each of the selective oxidation removal units as long as the plurality of selective oxidation removal units having a different temperature range at which the catalytic activity thereof exceeds a certain level, i.e., catalysts whose active temperature range is different, are placed in a serial manner.

Further, although Pt is carried as a metallic catalyst in the above-mentioned first and the second embodiments, catalysts that may be used in the present invention are not limited to Pt, and other metals, such as rhodium (Rh), palladium (Pd), iridium (Ir), ruthenium (Ru), and osmium (Os), etc., and suitable alloys thereof may be used according to the present invention.

Having thus described several exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the invention is limited and defined only by the following claims and equivalents thereto.

What is claimed is:

1. A device for carbon monoxide removal by selective oxidation, comprising:
carbon monoxide selective oxidation catalyst layers each containing a carbon monoxide selective oxidation catalyst which reduces the concentration of carbon monoxide contained in a gas by oxidation, wherein
said carbon monoxide selective oxidation catalyst layers are serially connected to each other, and
the amount of metallic catalyst contained in each of said carbon monoxide selective oxidation catalyst layers is larger than the amount in the preceding carbon monoxide selective oxidation catalyst layer from the upstream side to the downstream side in the flow direction of said gas.

2. A device for carbon monoxide removal by selective oxidation according to claim 1, further comprising:
an air introducing unit, and
a gas temperature controlling unit, wherein
said air introducing unit and said gas temperature controlling unit are disposed at the upstream side of said carbon monoxide selective oxidation catalyst layer in the flow direction of said gas.

3. A device for carbon monoxide removal by selective oxidation according to claim 1, further comprising:
a reactor provided between said carbon monoxide selective oxidation catalyst layers serially connected.

4. A device for carbon monoxide removal by selective oxidation according to claim 2, further comprising:
a reactor provided between said carbon monoxide selective oxidation catalyst layers serially connected.

5. A device for carbon monoxide removal by selective oxidation according to claim 1, further comprising:
a second carbon monoxide selective oxidation catalyst layer connected to said carbon monoxide selective oxidation catalyst layer in a parallel manner.

6. A device for carbon monoxide removal by selective oxidation according to claim 2, further comprising:
a second carbon monoxide selective oxidation catalyst layer connected to said carbon monoxide selective oxidation catalyst layer in a parallel manner.

7. A device for carbon monoxide removal by selective oxidation according to claim 1, wherein said metallic catalyst comprises a precious metal.

8. A device for carbon monoxide removal by selective oxidation, comprising:
carbon monoxide selective oxidation catalyst layers each containing a carbon monoxide selective oxidation catalyst which reduces the concentration of carbon monoxide contained in a gas by oxidation, wherein
said carbon monoxide selective oxidation catalyst layers are serially connected to each other, and
the length of each of said carbon monoxide selective oxidation catalyst layer is longer than the length of the preceding carbon monoxide selective oxidation catalyst layer from the upstream side to the downstream side in the flow direction of said gas.

9. A device for carbon monoxide removal by selective oxidation according to claim 8, further comprising:
an air introducing unit, and
a gas temperature controlling unit, wherein
said air introducing unit and said gas temperature controlling unit are disposed at the upstream side of said carbon monoxide selective oxidation catalyst layer.

10. A device for carbon monoxide removal by selective oxidation according to claim 8, further comprising:
a reactor provided between said carbon monoxide selective oxidation catalyst layers serially connected.

11. A device for carbon monoxide removal by selective oxidation according to claim 9, further comprising:
a reactor provided between said carbon monoxide selective oxidation catalyst layers serially connected.

12. A device for carbon monoxide removal by selective oxidation according to claim 8, further comprising:
a second carbon monoxide selective oxidation catalyst layer connected to said carbon monoxide selective oxidation catalyst layer in a parallel manner.

13. A device for carbon monoxide removal by selective oxidation according to claim 9, further comprising:
a second carbon monoxide selective oxidation catalyst layer connected to said carbon monoxide selective oxidation catalyst layer in a parallel manner.

14. A device for carbon monoxide removal by selective oxidation according to claim 8, wherein said metallic catalyst comprises a precious metal.

15. A carbon monoxide selective oxidation removing method in which the concentration of carbon monoxide contained in a gas is reduced by making said gas pass through a plurality of carbon monoxide selective oxidation catalyst layers, the method comprising:
a first step in which said gas is passed through a first carbon monoxide selective oxidation catalyst layer including a relatively small amount of a metallic catalyst; and
a second step carried out subsequently to said first step in which said gas is passed through a second carbon monoxide selective oxidation catalyst layer including a relatively large amount of a metallic catalyst.

16. A carbon monoxide selective oxidation removing method according to claim 15, further comprising steps of:
introducing an air into said gas and adjusting the temperature of said gas prior to said first step; and
introducing an air into said gas and adjusting the temperature of said gas prior to said second step.

17. A carbon monoxide selective oxidation removing method according to claim 15, wherein said metallic catalyst comprises a precious metal.

18. A carbon monoxide selective oxidation removing method in which the concentration of carbon monoxide contained in a gas is reduced by making said gas pass through a plurality of carbon monoxide selective oxidation catalyst layers, comprising:
a first step in which said gas is passed through a first carbon monoxide selective oxidation catalyst layer having a relatively short length in the flow direction of said gas; and
a second step carried out subsequently to said first step in which said gas is passed through a second carbon monoxide selective oxidation catalyst layer having a relatively long length in the flow direction of said gas.

19. A carbon monoxide selective oxidation removing method according to claim 18, further comprising steps of:
introducing an air into said gas and adjusting the temperature of said gas prior to said first step; and
introducing an air into said gas and adjusting the temperature of said gas prior to said second step.
